(19) United States
(12) Patent Application Publication
(10) Pub. No.: US 2025/0178100 A1
(43) Pub. Date: Jun. 5, 2025

(54) WORK MATERIAL STABILIZER FOR A LATHE

(71) Applicant: Gary Craft, Durand, MI (US)

(72) Inventor: Gary Craft, Durand, MI (US)

(21) Appl. No.: 18/524,374

(22) Filed: Nov. 30, 2023

(51) Int. Cl. B23B 31/02; B23B 23/04

(52) U.S. Cl. CPC B23B 29/16; B23Q 1/766; B23B 2260/008

(57) ABSTRACT

A work material stabilizer for a lathe. The work material stabilizer comprises a center support bar having a predetermined opening from side to side and near one of the end pieces. The center support is detachedly affixed to a linear slide block and the linear slide block is detachedly affixed to a linear slide bar and the linear slide bar is detachedly affixed to a metal cutting bar. There is a bearing having a centered opening located in an opening in the center support bar.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The applicant is not aware of any published prior art.

### BRIEF SUMMARY OF THE INVENTION

This invention deals with a work material stabilizer for a lathe. The work material stabilizer comprises in combination a center support bar having a top, a bottom, two end pieces and two sides. The center support bar has a predetermined opening from side to side and near one of the end pieces. The center support is detachedly affixed to a linear slide block and the linear slide block is detachedly affixed to a linear slide bar and the linear slide bar is detachedly affixed to a metal cutting bar. There is a bearing having a centered opening located in the predetermined opening.

### BRIEF DESCRIPTION OF THE SEVERAL VIEWS OF THE DRAWING(S)

FIG. 1 is a full top view of a device 1 of this invention with accompanying lathe components.

FIG. 2 is a full side view of a center support bar of this invention.

FIG. 3 is full end view of the rail of the slide bar surmounted on the cutting bar.

FIG. 4 is a full top view of the slide block of this invention.

FIG. 5 is a full end view of the slide block of FIG. 4.

### DETAILED DESCRIPTION OF THE INVENTION

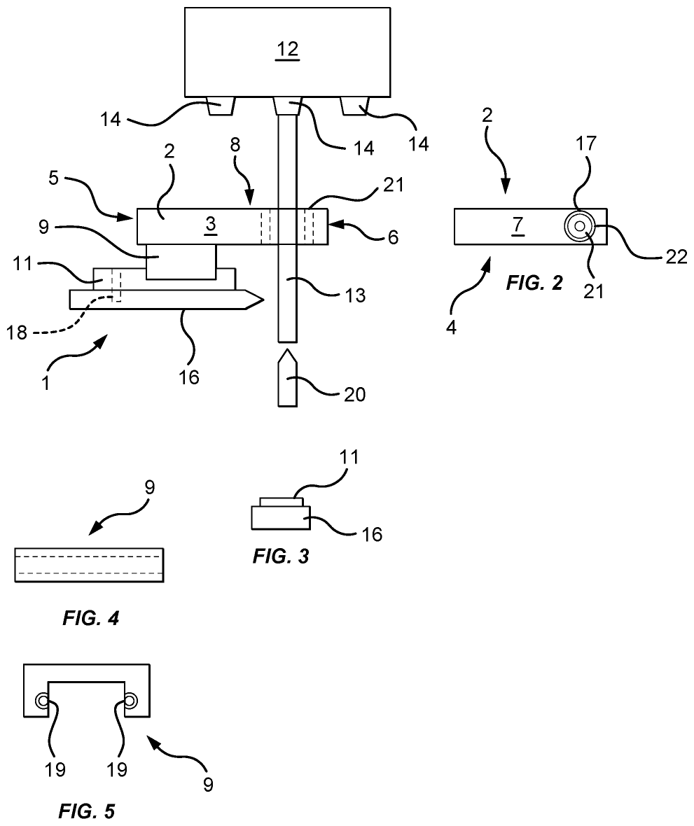

Turning now to the detailed description of the drawings, there is shown in FIG. 1 a full top view of a device 1 of this invention with accompanying lathe components. The lathe components are not considered part of this device but are shown because such components are required to use the device of this invention.

There is shown a center support 2 having a top 3, a bottom 4, two end pieces 5 and 6, and two sides 7 and 8. The center support bar 2 has a predetermined opening 17 from side to side and near end 6. The center support 2 is detachedly affixed to a linear slide block 9. Linear slide blocks are commercially available, for example, from MiSuMi, Schaumburg, Illinois 60173 USA. The linear slide block 9 is comprised of two components, a rail portion 11 and the slide block per se 9. The linear side block 9 is detachedly affixed (see 18 on FIG. 1 in phant22) to a linear slide bar (rail portion 11) and the linear slide bar 11 is detachedly affixed to a metal cutting bar 16.

The linear slide bar 9 is lined on the interior with ball bearings 19 so that the component slides easily on the block 11.

There is shown a lathe material holder 12, that is a chuck for holding work pieces 13 being used in the lathe. Also shown are jaws 14 of the chuck that actually holds the workpiece 13. The workpiece 13 shown in FIG. 1 is, for example, a solid metal rod. The workpieces 13 are held on the non-jaw end by a centering device 20 which is common in lathe work.

The center support 2 contains a predetermined opening 17 near end 6 of the center support 2. See FIG. 2. The opening 17 contains a roller or ball bearing 21 with a centered opening 22 that allows up to 1 inch of material to be supported. What is most efficient is the use of this device 1 on very small diameter work pieces.

The device 1 is used for materials being small in size and therefore vulnerable to bending and extreme movement. For purposes of this invention, the size of the work piece 13 may be as large as 4 inch and as small as 1/32 in diameter. The device 1 supports and prevents the work piece from bending or otherwise moving out-of-center on the lathe.

The bearings 21 can be exchanged and it is contemplated that there is a set of ball or roller bearings having a diameter sufficient to fit into the opening 17, and also to have the needed opening 22 to fit the working material 13. Thus, the opening 22 can be used that fits the working material 13 by just simply changing bearings 21.

The devices of this invention have been found to be useful in both CNC and standard lathes.

What is claimed is:

1. A work material stabilizer for a lathe, said work material stabilizer comprising in combination:
A. a center support bar having a top, a bottom, two end pieces and two sides, said center support bar having a predetermined opening from side to side and near one of said ends; said center support being detachedly affixed to a
B. a linear slide block and said linear slide block being detachedly affixed to a linear slide bar and said linear slide bar is detachedly affixed to a metal cutting bar;
C. a bearing having a centered opening located in said predetermined opening.

2. In combination, the work material stabilizer of claim 1 and
a. a metal material working piece located in and through said predetermined opening;
b. said material work piece being held by jaws of a chuck of a lathe by one end of said material work piece;
c. an opposite end of said material work piece being held by a lathe centering piece.

3. The work material stabilizer as claimed in claim 1 manufactured from metal.

4. The work material stabilizer as claimed in claim 3 wherein the metal is steel.

5. The work material stabilizer as claimed in claim 3 wherein the metal is steel.

6. The work material stabilizer as claimed in claim 1 wherein said bearing outside diameter is consistent in size and said centered opening in said bearing is varied in size to accommodate various sizes of material work pieces.
